(19) United States
(12) Patent Application Publication
(10) Pub. No.: US 2021/0271993 A1
(43) Pub. Date: Sep. 2, 2021

(54) OBSERVED EVENT DETERMINATION APPARATUS, OBSERVED EVENT DETERMINATION METHOD, AND COMPUTER READABLE RECORDING MEDIUM

(71) Applicant: NEC Corporation, Minato-ku, Tokyo (JP)

(72) Inventor: Daichi KIMURA, Tokyo (JP)

(73) Assignee: NEC Corporation, Minato-ku, Tokyo (JP)

(21) Appl. No.: 17/258,303

(22) PCT Filed: Jul. 6, 2018
(86) PCT No.: PCT/JP2018/025722

§ 371 Date: Jan. 6, 2021

(51) Int. Cl. G06N 5/04; G06N 5/02; G06F 9/54

(52) U.S. Cl. CPC G06N 5/042; G06F 9/542; G06N 5/022

(57) ABSTRACT

An observed event determination apparatus 10, includes: a data receiving unit 11 configured to receive observed event data indicating an observed event; and a data determining unit 12 configured to determine whether or not the received observed event data is not needed based on pieces of observed event data other than the received observed event data and knowledge data.

### TECHNICAL FIELD

The present invention relates to an observed event determination apparatus and an observed event determination method for determining the necessity of an observed event to be used in inference, and further relates to a computer readable recording medium that includes a program for realizing the same recorded thereon.

### BACKGROUND ART

Heretofore, attempts have been made to execute inference by computer (see Patent Documents 1 to 4). If the inference is performed by a computer, it is possible to infer various situations based on information obtained from facts. Therefore, the inference by the computer is useful for the foregoing situations such as store roll-out plans, criminal investigations, evacuations at the time of disasters, environmental management, and the like, and it is expected to improve the accuracy of simulations by using the inference.

Also, in the abductive inference, as an example of the inference, a valid hypothesis is derived from knowledge (rules) and observed events (obtained facts). For example, it is assumed that “AB (if A holds true, then B holds true)” is present as the knowledge, and “B holds true” is acquired as an observed event. In this case, “A holds true” is obtained as a hypothesis by the inference. Note that, in the following, the abductive inference may also be called “backward inference”. Also, the process of searching A from B is referred to as “tracing back the inference”.

### LIST OF RELATED ART DOCUMENTS

### Patent Document

Patent Document 1: Japanese Patent Laid-Open Publication No. H09-213081

Patent Document 2: Japanese Patent Laid-Open Publication No. H10-333911

Patent Document 3: Japanese Patent Laid-Open Publication No. 2000-242499

Patent Document 4: Japanese Translation of PCT Application No. 2015-502617

### SUMMARY OF INVENTION

### Problems to be Solved by the Invention

Incidentally, normally, the knowledge is set manually in the inference, but the observed events are acquired in a large amount from logs at the time of system operation or the like. Therefore, there is a problem in that, in known systems that perform inference, the processing time needed to perform the inference largely increases due to the accumulation of the observed events.

On the other hand, all of the acquired observed events are not necessarily needed in the inference, and unnecessary observed events are present in the acquired observed events. Therefore, if the unnecessary observed events can be specified from the acquired observed events, the foregoing problem can be considered to be solved. However, the known systems that perform inference do not include such a function, and it is difficult to solve the foregoing problem.

An example object of the invention is to solve the foregoing problem and provide an observed event determination apparatus, an observed event determination method, and a computer readable recording medium that enable observed event data that is not needed in inference to be specified.

### Means for Solving the Problems

To achieve the above-stated example object, an observed event determination apparatus according to an example aspect of the invention includes:

a data receiving unit configured to receive observed event data indicating an observed event; and

a data determining unit configured to determine whether or not the received observed event data is not needed based on pieces of observed event data other than the received observed event data and knowledge data.

Also, to achieve the above-stated example object, an observed event determination method according to an example aspect of the invention includes:

(a) a step of receiving observed event data indicating an observed event; and

(b) a step of determining whether or not the received observed event data is not needed based on pieces of observed event data other than the received observed event data and knowledge data.

Furthermore, to achieve the above-stated example object, a computer-readable recording medium according to an example aspect of the invention is a computer-readable recording medium that includes a program recorded thereon, the program including instructions that cause the computer to carry out:

(a) a step of receiving observed event data indicating an observed event; and

(b) a step of determining whether or not the received observed event data is not needed based on pieces of observed event data other than the received observed event data and knowledge data.

### Advantageous Effects of the Invention

As described above, according to the invention, observed event data that is not needed in inference can be specified.

### BRIEF DESCRIPTION OF THE DRAWINGS

FIG. 1 is a block diagram illustrating a configuration of an observed event determination apparatus according to a present example embodiment of the invention.

FIG. 2 is a diagram illustrating a function of a data determining unit of the observed event determination apparatus according to the present example embodiment of the invention.

FIG. 3 is a diagram illustrating an example of an extension function of the data determining unit of the observed event determination apparatus according to the present example embodiment of the invention.

FIG. 4 is a diagram illustrating an example of a directed graph obtained by the extension function illustrated in FIG. 3.

FIG. 5 is a diagram illustrating another example of the extension function of the data determining unit of the observed event determination apparatus according to the present example embodiment of the invention.

FIG. 6 is a flow diagram illustrating operations of the observed event determination apparatus 10 according to the present example embodiment of the invention.

FIG. 7 is a diagram illustrating conditions of a specific example of processing performed in the present example embodiment of the invention.

FIG. 8 is a block diagram illustrating an example of a computer that realizes the observed event determination apparatus 10 according to the present example embodiment of the invention.

### EXAMPLE EMBODIMENT

### Example Embodiment

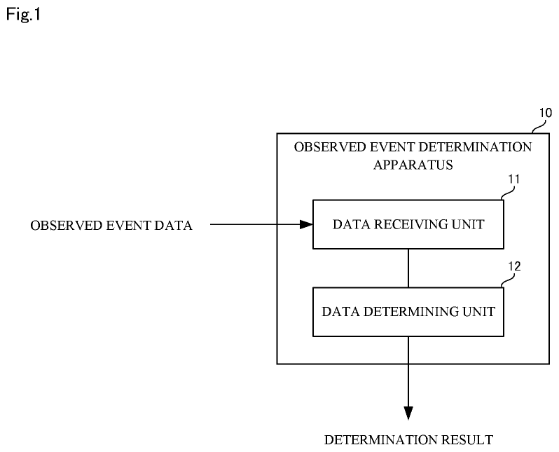

Hereinafter, an observed event determination apparatus, an observed event determination method, and a computer readable recording medium according to the present example embodiment of the invention will be described with reference to FIGS. 1 to 8.

[Configuration of the Invention]

First, the configuration of the observed event determination apparatus according to the present example embodiment of the invention will be described. FIG. 1 is a block diagram illustrating the configuration of the observed event determination apparatus according to the present example embodiment of the invention.

The observed event determination apparatus 10 according to the present example embodiment shown in FIG. 1 is an apparatus that determines the necessity of an observed event to be used in inference. As shown in FIG. 1, the observed event determination apparatus 10 includes a data receiving unit 11 and a data determining unit 12.

The data receiving unit 11 receives observed event data indicating an observed event. The observed event data includes an observation such as “isFile(Data)”, for example. The observation is a conjunction of first-ordered literals. The data determining unit 12 determines whether or not the received observed event data is not needed based on pieces of observed event data other than the received observed event data and knowledge data.

As described above, in the present example embodiment, it is appropriately determined whether or not the received observed event data is needed, and the observed event data that is not needed in the inference is specified. According to the present example embodiment, the increase in time needed for deriving a hypothesis due to accumulation of the observed event data in a large amount can be suppressed.

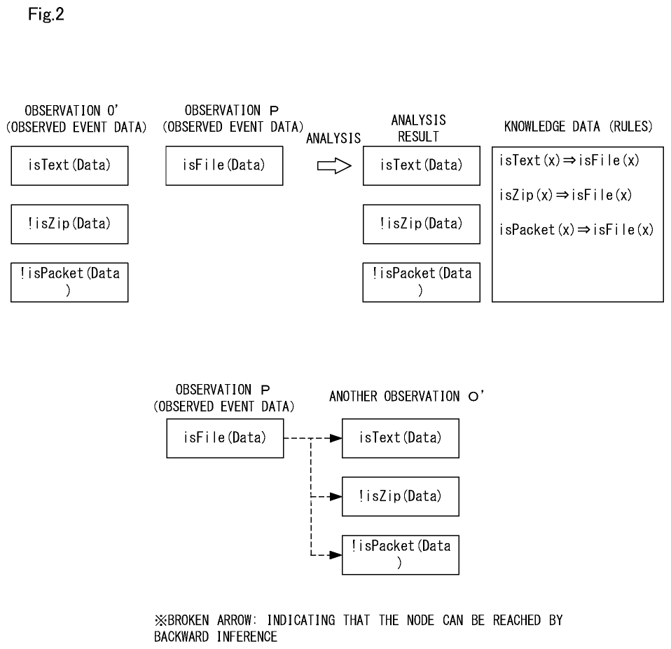

Next, the function of the observed event determination apparatus 10 according to the present example embodiment will be described using FIG. 2 in addition to FIG. 1. FIG. 2 is a diagram illustrating the function of the data determining unit of the observed event determination apparatus according to the present example embodiment of the invention.

In the present example embodiment, the data determining unit 12, first, executes an analysis on the received observed event data based on knowledge data. Also, the data determining unit 12, if it is determined that the received observed event data can be derived from the analysis result and other pieces of observed event data, determines that the received observed event data is not needed.

Specifically, it is assumed that observed event data “isFile(Data)” has been observed as an observation P, and pieces of observed event data “isText(Data)”, “!isZip(Data)”, and “!isPacket(Data)” are observed as an observation O′, as shown in FIG. 2. Also, “isText(x)⇒isFile(x)”, “isZip(x)⇒isFile(x)”, and “isPacket(x)⇒isFile(x)” are present as knowledge data (rules). Here, “!” is used as a symbol indicating negation.

In this case, the data determining unit 12 acquires “isText(Data)”, “!isZip(Data)”, and “!isPacket(Data)” as the analysis result of the observation P, for example. Also, in the example in FIG. 2, the literals included in the acquired analysis result are included in the other observation (observed event data) O′ (“isText(Data)”, “!isZip(Data)”, and “!isPacket(Data)”). Therefore, in this case, the data determining unit 12 can determine that the observation P can be derived from the analysis result and other pieces of observed event data, and therefore determines that the observation P is not needed.

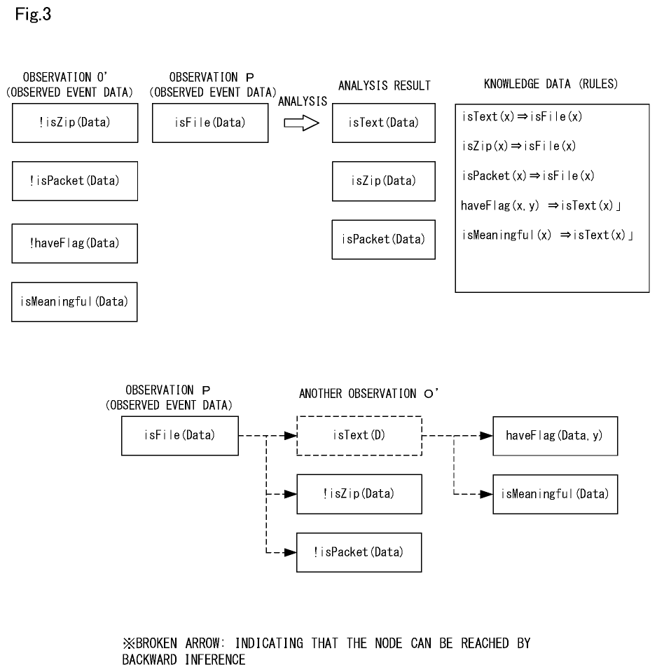

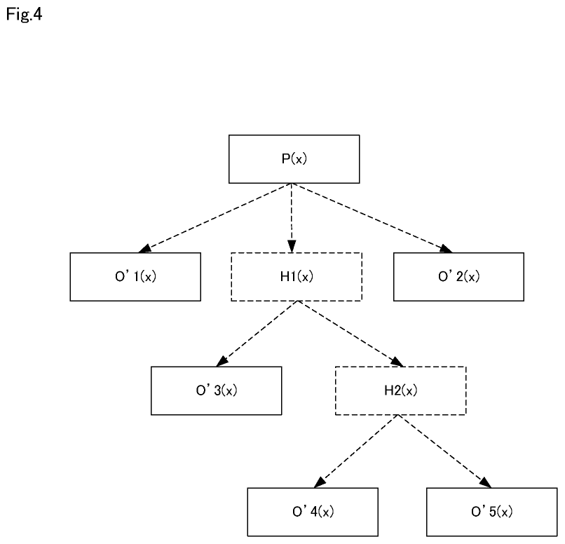

Moreover, the extension function of the data determining unit 12 will be described using FIGS. 3 to 5. FIG. 3 is a diagram illustrating an example of the extension function of the data determining unit of the observed event determination apparatus according to the present example embodiment of the invention. FIG. 4 is a diagram illustrating an example of a directed graph obtained by the extension function illustrated in FIG. 3.

In the example in FIG. 3, the data determining unit 12 first performs backward inference on received observed event data as the analysis. Also, the data determining unit 12 can also execute the analysis using the upper-lower relationship in an ontology instead of the backward inference, for example.

Next, the data determining unit 12 determines that the received observed event data is not needed on a condition that, with respect to the obtained inference result, when the inference is traced back from the received observed event data, any of the other pieces of observed event data are necessarily reached.

Specifically, in the example in FIG. 3, it is assumed that “isFile(Data)” is observed as an observation P, and “!isZip(Data)”, “!isPacket(Data)”, “!haveFlag(Data,y)”, and “! isMeaningful(Data)” are observed as an observation O′. On the other hand, it is assumed that “haveFlag(x,y)⇒isText(x)” and “isMeaningful(x)⇒isText(x)” are also present as the knowledge data in addition to “isText(x)⇒isFile(x)”, “isZip(x)⇒isFile(x)”, “isPacket(x)⇒isFile(x)” shown in the example in FIG. 2. In this case, when the data determining unit 12 performs the analysis (backward inference) on the observation P, “isText(Data)”, “isZip(Data)”, and “isPacket(Data) are obtained.

Incidentally, in the example in FIG. 3, “!isZip(Data)”, “!isPacket(Data)”, “!haveFlag(Data,y)”, and “!isMeaningful(Data)” are included in the other observed event data O′, but “isText(Data)” is not included. Therefore, in the example in FIG. 2, it is determined that the observation P cannot be deleted. Note that, in the following, the affirmative literal (“isZip(Data)” and the like) is treated as the same as the negation literal (“!isZip(Data)” and the like).

In contrast, in the example in FIG. 3, “haveFlag(x,y)⇒isText(x)” and “isMeaningful(x)⇒isText(x)” are further included as the knowledge data. In this case, when the data determining unit 12 performs backward inference on “isText(Data)”, which is the previous inference result, “haveFlag(Data,y)” and “isMeaningful(Data) are acquired. Also, these are included in the other observed event data O′, and therefore, the data determining unit 12 determines that the observation P is not needed. Note that, in FIG. 3, the literals surrounded by solid lines indicate observed literals, and the literals surrounded by broken lines indicates unobserved literals.

Also, FIG. 4 shows a directed graph formed by backward inference from the observation P. In the directed graph shown in FIG. 4, when movement is performed according to the directions of the links from the observation P, if any of the literals of the observation O′ can be necessarily reached, it is possible to delete the observation P.

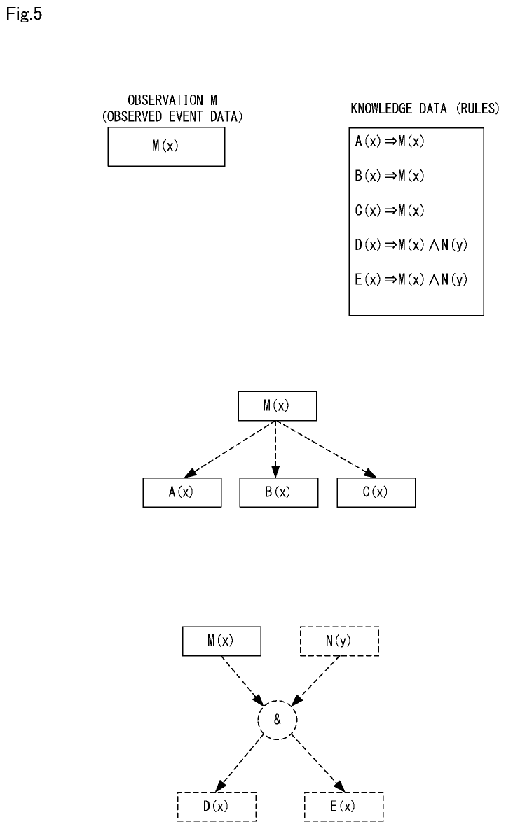

FIG. 5 is a diagram illustrating another example of the extension function of the data determining unit of the observed event determination apparatus according to the present example embodiment of the invention. In the example in FIG. 5, first, the condition is whether or not the received observed event data and an event expected to be observed hold true at the same time.

In other words, in the example in FIG. 5, the condition is that a rule is present that includes a consequent in which an observation that is included in the observed event data and the observation indicating the event expected to be observed forms conjunction. In the example in FIG. 5, “D(x)⇒M(x)\hat{ }N(y)” and “E(x)⇒M(x)\hat{ }N(y)” are corresponded to. Also, the data determining unit 12 determines, under this condition, that the received observed event data is not needed if the event expected to be observed has not been observed, or if the event expected to be observed cannot be derived by backward inference from other observations based on the knowledge data.

Specifically, it is assumed that “M(x)” has been observed as an observation M, as shown in FIG. 5. Also, it is assumed that “A(x)⇒M(x)”, “B(x)⇒M(x)”, “C(x)⇒M(x)”, “D(x)⇒M(x)\hat{ }N(y)”, and “E(x)⇒M(x)\hat{ }N(y)” are present as the knowledge data. Also, the tree shown in the middle part of FIG. 5 illustrates a directed graph created by backward inference from the observation M. The tree shown in the lower part of FIG. 5 illustrates a directed graph created by backward inference from the observation M and an observation N (observed event data: N(y)). Note that the conjunction is expressed by using a symbol “&” in FIG. 5.

Under this condition, consider a situation in which “A(x)”, “B(x)”, and “C(x)” have been observed as an observation O′, and on the other hand, “D(x)” and “E(x)” have not been observed. Here, if an event N(y) expected to be observed has not been observed, or N(y) cannot be acquired as the hypothesis by backward inference from the observations M and O′ based on the knowledge data, the data determining unit 12 determines that the observation M is not needed.

Here, the extension function shown in FIG. 5 will be described in more detail. First, it is assumed that the following rules are present as the knowledge data. Also, each knowledge data belongs to one of groups 1 to 3, for convenience.

(group 1)
A(x)⇒M(x)
B(x)⇒M(x)
C(x)⇒M(x)
   (group 2)
D(x)⇒M(x)\hat{ }N(y)
E(x)⇒M(x)\hat{ }N(y)
   (group 3)
F(x)⇒M(x)\hat{ }L(y)
G(x)⇒M(x)\hat{ }L(y)

In the aforementioned example, if A(x), B(x), and C(x) are observed, and N(y) and L(y) are not observed or not obtained as a hypothesis, the data determining unit 12 determines that M(x) is not needed (can be deleted) based on the analysis (backward inference) using the knowledge data of the group 1.

Also, in the aforementioned example, if A(x), B(x), C(x), D(x), and E(x) are observed, and L(y) is not observed or not obtained as a hypothesis, the data determining unit 12 determines that M(x) is not needed (can be deleted) based on the analysis (backward inference) using the knowledge data of the groups 1 and 2.

Moreover, in the aforementioned example, if A(x), B(x), C(x), F(x), and G(x) are observed, and N(y) is not observed or not obtained as a hypothesis, the data determining unit 12 determines that M(x) is not needed (can be deleted) based on the analysis (backward inference) using the knowledge data of the groups 1 and 3.

Also, as shown in the following, it is assumed that each knowledge data includes M(x)\hat{ }K(z) in the consequent. In this case, if M(x) and K(z) have been observed, it may be obvious that the data determining unit 12 can execute determination similarly to the example described above. That is, “M(x)” in the example described above need only be replaced by “M(x)\hat{ }K(z)”.

(group 1)
A(x)⇒M(x)\hat{ }K(z)
B(x)⇒M(x)\hat{ }K(z)
C(x)⇒M(x)\hat{ }K(z)
   (group 2)
D(x)⇒M(x)\hat{ }K(z)\hat{ }N(y)
E(x)⇒M(x)\hat{ }K(z)\hat{ }N(y)
   (group 3)
F(x)⇒M(x)\hat{ }K(z)\hat{ }L(y)
G(x)⇒M(x)\hat{ }K(z)\hat{ }L(y)

Also, as shown in the following, it is assumed that knowledge data is present in which a plurality of literals are present in the antecedent. In this case, the data determining unit 12 determines that the literal in the consequent is not needed (can be deleted) on the condition that all of the literals in the antecedent have been observed.

### A1(x)\hat{ }A2(x)⇒M(x)

### B1(x)\hat{ }B2(x)⇒M(x)

[Apparatus Operations]

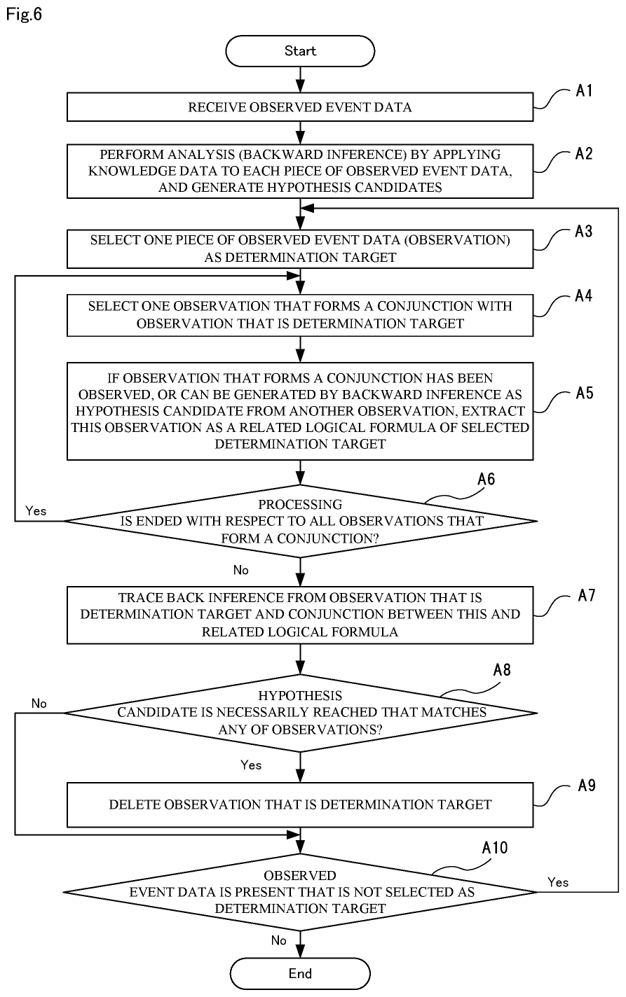

Next, the operations of the observed event determination apparatus 10 according to the present example embodiment of the invention will be described using FIG. 6. FIG. 6 is a flow diagram illustrating the operations of the observed event determination apparatus 10 according to the present example embodiment of the invention. In the following description, FIGS. 1 to 5 will be referred to as appropriate. Furthermore, in the present example embodiment, the observed event determination method is carried out by causing the observed event determination apparatus 10 to operate. Therefore, the following description of the operations of the observed event determination apparatus 10 applies to the observed event determination method according to the present example embodiment.

As shown in FIG. 6, first, the data receiving unit 11 receives observed event data indicating an observed event (step A1). The number of pieces of observed event data received in step A1 may be one or two or more.

Next, the data determining unit 12 performs analysis (backward inference) by applying knowledge data to each observed event data received in step A1, and generates hypothesis candidates based on the analysis (step A2).

Next, the data determining unit 12 selects one of the pieces of observed event data (observations) as a determination target (step A3).

Next, the data determining unit 12 selects one of the logical formulas that form conjunction with the observation that is the determination target selected in step A3 (step A4).

Next, if the observation selected in step A4 has been observed, or can be generated as a hypothesis candidate by backward inference from another observation, the data determining unit 12 extracts this observation as a related logical formula of the determination target selected in step A3 (step A5).

Next, the data determining unit 12 determines whether or not the processing in step A5 has been ended with respect to all of the logical formulas that form conjunction with the observation that is the determination target selected in step A3 (step A6).

If, as a result of the determination in step A6, the processing in step A5 has not been ended with respect to all of the logical formulas that form conjunction with the observation that is the determination target selected in step A3, the data determining unit 12 again executes processing in step A4.

On the other hand, if as a result of the determination in step A6, the processing in step A5 has been ended with respect to all of the logical formulas that form conjunction with the observation that is the determination target selected in step A3, the data determining unit 12 executes processing in step A7.

In step A7, the data determining unit 12 traces back the inference from the observation that is the determination target selected in step A3 and from the conjunction between this and the related logical formula.

Also, the data determining unit 12 determines, based on the result in step A7, whether or not, when the inference is traced back from the observation that is the determination target selected in step A3 and the conjunction between this and the related logical formula, a hypothesis candidate that matches any of the pieces of observed event data (observations) received in step A1 is necessarily reached (step A8).

As a result of the determination in step A8, if a hypothesis candidate that matches any of the pieces of observed event data (observations) received in step A1 is not reached, the data determining unit 12 executes the processing in step A10.

On the other hand, as a result of the determination in step A8, if a hypothesis candidate that matches any of the pieces of observed event data (observations) received in step A1 is reached, the data determining unit 12 deletes the observation that is the determination target selected in step A3 (step A9). Thereafter, the data determining unit 12 executes the processing in step A10.

In step A10, the data determining unit 12 determines whether or not a piece of observed event data that has not been selected as the determination target is present. As a result of the determination in step A10, if a piece of observed event data that has not been selected as the determination target is present, the data determining unit 12 again executes the processing in step A3.

On the other hand, As a result of the determination in step A10, if a piece of observed event data that has not been selected as the determination target is not present, the data determining unit 12 ends the processing.

### Specific Example

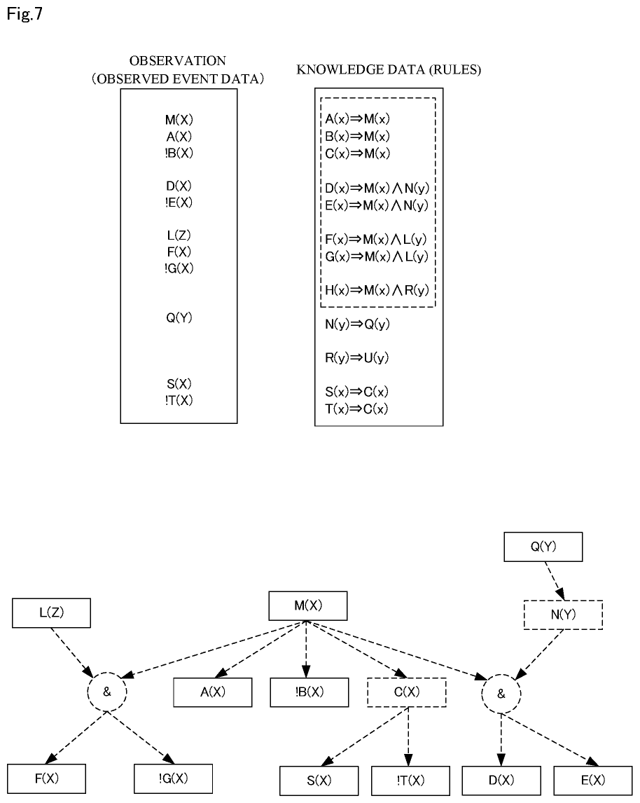

Next, a specific example will be described using FIG. 7. FIG. 7 is a diagram illustrating conditions of a specific example of processing performed in the present example embodiment of the invention.

First, it is assumed that “A(x)⇒M(x)”, “B(x)⇒M(x)”, “C(x)⇒M(x)”, “D(x)⇒M(x)\hat{ }N(y)”, “E(x)⇒M(x)\hat{ }N(y)”, “F(x)⇒M(x)\hat{ }L(y)”, “G(x)⇒M(x)\hat{ }L(y)”, “H(x)⇒M(x)\hat{ }R(y)”, “N(y)⇒Q(y)”, “R(y)⇒U(y)”, “S(x)⇒C(x)”, and “T(x)⇒C(x)” are the knowledge data, as shown in FIG. 7.

(Step A1)

As shown in FIG. 7, in step A1, the data receiving unit 11 acquires “M(x)”, “A(x)”, “!B(x)”, “D(x)”, “!E(x)”, “L(z)”, “F(x)”, “!G(x)”, “Q(y)”, “S(x)”, and “!T(x)” as the pieces of observed event data.

(Step A2)

Next, the data determining unit 12 performs the backward inference by applying the knowledge data to each piece of observed event data, and with this, generates hypothesis candidates. The generation result of hypothesis candidates is as shown by the directed graph in FIG. 7.

(Steps A3 and A4)

Next, the data determining unit 12 selects M(x) as the observed event data. In FIG. 7, the knowledge data, which is surrounded by broken lines, indicates knowledge data including M(x). Also, in FIG. 7, the logical formulas that form conjunction with M(x) are L(y), N(y), and R(y), and therefore the determining unit 12 sequentially selects one of these.

(Step A5)

For example, it is assumed that L(y) has been selected, in step A4, as the logical formula that forms a conjunction with M(x). Because L(z) is present in the observed event data, the data determining unit 12 extracts L(y) as a related logical formula.

Also, it is assumed that N(y) has been selected as the logical formula that forms a conjunction with M(x). Although N(y) is not present in the observed event data, “N(y)⇒Q(y)” is present in the knowledge data and Q(y) is present in the observed event data, and therefore N(y) can be generated as a hypothesis candidate. Therefore, the data determining unit 12 extracts N(y) as a related logical formula.

Moreover, it is assumed that R(y) has been selected as the logical formula that forms a conjunction with M(x). R(y) is not present in the observed event data, and furthermore, although “R(y)⇒U(y)” is present in the knowledge data, U(y) is not present in the observed event data, and therefore R(y) cannot be generated as the hypothesis candidate. Therefore, the data determining unit 12 does not extract R(y) as the related logical formula.

(Steps A7 and A8)

The data determining unit 12 traces back the inference from M(x), from M(x)\hat{ }L(z), and from M(x)\hat{ }N(y), and determines whether or not a hypothesis candidate that matches any of the pieces of observed event data (observation) is reached.

Specifically, a hypothesis candidate A(X) that is present at a node that can be reached from M(X) matches the observation A(X), and similarly, a hypothesis candidate B(X) matches the observation !B(X). Also, C(X) that is present at a node that can be reached from M(X) does not match any of the observations, but S(X) and !T(X) that are present at nodes that can be reached by further tracing back match the observation. Moreover, F(X) and !G(X) that are present at nodes that can be reached from M(x)\hat{ }L(z) also match the observation. Also, D(X) and ! E(X) that are present at nodes that can be reached from M(X)\hat{ }N(Y) also match the observation.

(Step A9)

As a result of the determination in step A8, it is determined that, as a result of tracing back the inference from the observation that is the determination target, and from the conjunction between the observation and a related logical formula, a hypothesis candidate that matches any of the observations is necessarily reached. Therefore, the data determining unit 12 deletes M(X). Note that, if it is assumed that “!T(X)” has not been observed, in this case, as a result of tracing back the inference from the observation that is the determination target and the conjunction between the observation and a related logical formula, a hypothesis candidate that matches any of the observations is not necessarily reached, and therefore M(X) will not be deleted.

[Effects of Present Example Embodiment]

As described above, according to the present example embodiment, whether or not observed event data is needed is appropriately determined, and observed event data that is not needed in inference is specified and deleted. As a result, the increase in time needed to derive a hypothesis due to accumulation of observed event data in a large amount can be suppressed.

[Program]

A program according to the present example embodiment need only be a program for causing a computer to perform steps A1 to A10 shown in FIG. 6, for example. The observed event determination apparatus 10 and the observed event determination method according to the present example embodiment can be realized by installing this program on a computer and executing the program. In this case, a processor of the computer functions as the data receiving unit 11 and the data determining unit 12, and performs processing.

Also, the program according to the present example embodiment may also be executed by a computer system that includes a plurality of computers. In this case, for example, each of the computers may function as any of the data receiving unit 11 and the data determining unit 12.

[Physical configuration]

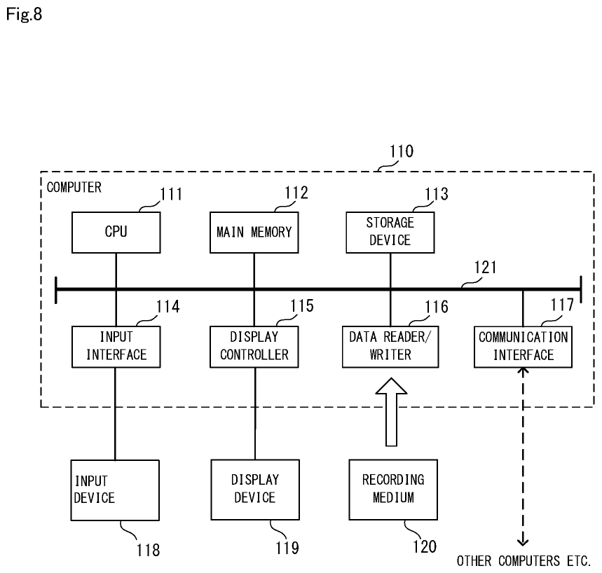

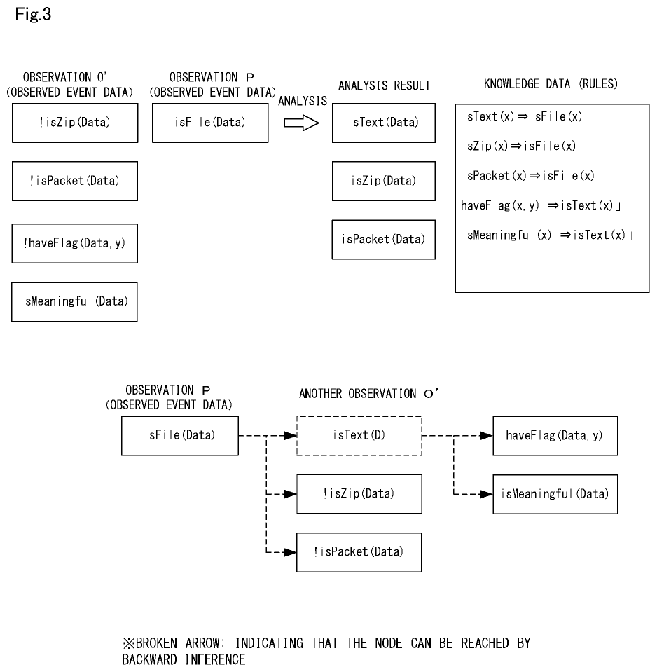

A description will now be given, with reference to FIG. 8, of a computer that realizes the observed event determination apparatus 10 by executing the program according to the present example embodiment. FIG. 8 is a block diagram illustrating an example of the computer that realizes the observed event determination apparatus 10 according to the present example embodiment of the invention.

As shown in FIG. 8, a computer 110 includes a CPU (Central Processing Unit) 111, a main memory 112, a storage device 113, an input interface 114, a display controller 115, a data reader/writer 116, and a communication interface 117. These units are connected to each other via a bus 121 so as to be able to communicate data. Note that the computer 110 may also include, in addition to the CPU 111 or in place of the CPU 111, a GPU (Graphics Processing Unit), or an FPGA (Field-Programmable Gate Array).

The CPU 111 loads the program (codes) according to the present example embodiment that is stored in the storage device 113 to the main memory 112 and executes the codes in a predetermined order, thereby performing various kinds of computation. The main memory 112 is typically a volatile storage device such as a DRAM (Dynamic Random Access Memory). The program according to the present example embodiment is provided in a state of being stored in a computer-readable recording medium 120. Note that the program according to the present example embodiment may also be distributed on the Internet to which the computer is connected via the communication interface 117.

Specific examples of the storage device 113 may include a hard disk drive, a semiconductor storage device such as a flash memory, and the like. The input interface 114 mediates data transmission between the CPU 111 and input devices 118 such as a keyboard and a mouse. The display controller 115 is connected to a display device 119 and controls a display in the display device 119.

The data reader/writer 116 mediates data transmission between the CPU 111 and the recording medium 120, reads out the program from the recording medium 120, and writes, in the recording medium 120, the results of processing performed by the computer 110. The communication interface 117 mediates data transmission between the CPU 111 and other computers.

Specific examples of the recording medium 120 may include a general-purpose semiconductor storage device such as a CF (Compact Flash (registered trademark)) or an SD (Secure Digital), a magnetic recording medium such as a Flexible Disk, and an optical recording medium such as a CD-ROM (Compact Disk Read Only Memory).

Note that, the observed event determination apparatus 10 according to the present example embodiment may also be realized using hardware that corresponds to each of the units, rather than a computer in which the program is installed. Furthermore, the observed event determination apparatus 10 may be partially realized by a program, and the remainder may be realized by hardware.

Part of, or the entire present example embodiment described above can be expressed by the following (Supplementary note 1) to (Supplementary note 12), but is not limited thereto.

(Supplementary Note 1)

An observed event determination apparatus, including:

a data receiving unit configured to receive observed event data indicating an observed event; and

a data determining unit configured to determine whether or not the received observed event data is not needed based on pieces of observed event data other than the received observed event data and knowledge data.

(Supplementary Note 2)

The observed event determination apparatus according to supplementary note 1,

wherein the data determining unit performs an analysis on the received observed event data based on the knowledge data, and determines that the received observed event data is not needed if it is determined that the received observed event data can be derived from the analysis result and the other pieces of observed event data.

(Supplementary Note 3)

The observed event determination apparatus according to supplementary note 1 or 2,

wherein the data determining unit performs backward inference on the received observed event data, and determines that the received observed event data is not needed on a condition that, with respect to the obtained inference result, when the inference is traced back from the received observed event data, any of the other pieces of observed event data are necessarily reached.

(Supplementary Note 4)

The observed event determination apparatus according to any of supplementary notes 1 to 3,

wherein the data determining unit determines, on a condition that the received observed event data and an event expected to be observed hold true at the same time, that the received observed event data is not needed if the event expected to be observed has not been observed, or if the event expected to be observed cannot be derived by backward inference from another observation based on the knowledge data.

(Supplementary Note 5)

An observed event determination method, including:

(a) a step of receiving observed event data indicating an observed event; and

(b) a step of determining whether or not the received observed event data is not needed based on pieces of observed event data other than the received observed event data and knowledge data.

(Supplementary Note 6)

The observed event determination method according to supplementary note 5,

wherein, in the (b) step, an analysis is performed on the received observed event data based on the knowledge data, and it is determined that the received observed event data is not needed if it is determined that the received observed event data can be derived from the analysis result and the other pieces of observed event data.

(Supplementary Note 7)

The observed event determination method according to supplementary note 5 or 6,

wherein, in the (b) step, backward inference is performed on the received observed event data, and it is determined that the received observed event data is not needed on a condition that, with respect to the obtained inference result, when the inference is traced back from the received observed event data, any of the other pieces of observed event data are necessarily reached.

(Supplementary Note 8)

The observed event determination method according to any of supplementary notes 5 to 7,

wherein, in the (b) step, it is determined, on a condition that the received observed event data and an event expected to be observed hold true at the same time, that the received observed event data is not needed if the event expected to be observed has not been observed, or if the event expected to be observed cannot be derived by backward inference from another observation based on the knowledge data.

(Supplementary Note 9)

A computer-readable recording medium that includes a program recorded thereon, the program including instructions that cause the computer to carry out:

(a) a step of receiving observed event data indicating an observed event; and

(b) a step of determining whether or not the received observed event data is not needed based on pieces of observed event data other than the received observed event data and knowledge data.

(Supplementary Note 10)

The computer-readable recording medium according to supplementary note 9,

wherein, in the (b) step, an analysis is performed on the received observed event data based on the knowledge data, and it is determined that the received observed event data is not needed if it is determined that the received observed event data can be derived from the analysis result and the other pieces of observed event data.

(Supplementary Note 11)

The computer-readable recording medium according to supplementary note 9 or 10,

wherein, in the (b) step, backward inference is performed on the received observed event data, and it is determined that the received observed event data is not needed on a condition that, with respect to the obtained inference result, when the inference is traced back from the received observed event data, any of the other pieces of observed event data are necessarily reached.

(Supplementary Note 12)

The computer-readable recording medium according to any of supplementary notes 9 to 11,

wherein, in the (b) step, it is determined, on a condition that the received observed event data and an event expected to be observed hold true at the same time, that the received observed event data is not needed if the event expected to be observed has not been observed, or if the event expected to be observed cannot be derived from another observation, under the situation in which new observed event data can be derived.

The invention of the present application has been described above with reference to the present example embodiment, but the invention of the present application is not limited to the above present example embodiment. The configurations and the details of the invention of the present application may be changed in various manners that can be understood by a person skilled in the art within the scope of the invention of the present application.

### INDUSTRIAL APPLICABILITY

As described above, according to the invention, observed event data that is not needed in inference can be specified. The invention is useful in a system in which inference is performed.

### LIST OF REFERENCE SIGNS

10 Observed event determination apparatus
11 Data receiving unit
12 Data determining unit
110 Computer
111 CPU
112 Main memory
113 Storage device
114 Input interface
115 Display controller
116 Data reader/writer
117 Communication interface
118 Input devices
119 Display device
120 Recording medium
121 Bus

What is claimed is:

1. An observed event determination apparatus, comprising:
a data receiving unit configured to receive observed event data indicating an observed event; and
a data determining unit configured to determine whether or not the received observed event data is not needed based on pieces of observed event data other than the received observed event data and knowledge data.

2. The observed event determination apparatus according to claim 1,
wherein the data determining unit performs an analysis on the received observed event data based on the knowledge data, and determines that the received observed event data is not needed if it is determined that the received observed event data can be derived from the analysis result and the other pieces of observed event data.

3. The observed event determination apparatus according to claim 1,
wherein the data determining unit performs backward inference on the received observed event data, and determines that the received observed event data is not needed on a condition that, with respect to the obtained inference result, when the inference is traced back from the received observed event data, any of the other pieces of observed event data are necessarily reached.

4. The observed event determination apparatus according to claim 1,
wherein the data determining unit determines, on a condition that the received observed event data and an event expected to be observed hold true at the same time, that the received observed event data is not needed if the event expected to be observed has not been observed, or if the event expected to be observed cannot be derived by backward inference from another observation based on the knowledge data.

5. An observed event determination method, comprising:
receiving observed event data indicating an observed event; and
determining whether or not the received observed event data is not needed based on pieces of observed event data other than the received observed event data and knowledge data.

6. The observed event determination method according to claim 5,
wherein, in the determining, an analysis is performed on the received observed event data based on the knowledge data, and it is determined that the received observed event data is not needed if it is determined that the received observed event data can be derived from the analysis result and the other pieces of observed event data.

7. The observed event determination method according to claim 5,
wherein, in the determining, backward inference is performed on the received observed event data, and it is determined that the received observed event data is not needed on a condition that, with respect to the obtained inference result, when the inference is traced back from the received observed event data, any of the other pieces of observed event data are necessarily reached.

8. The observed event determination method according to claim 5,
wherein, in the determining, it is determined, on a condition that the received observed event data and an event expected to be observed hold true at the same time, that the received observed event data is not needed if the event expected to be observed has not been observed, or if the event expected to be observed cannot be derived by backward inference from another observation based on the knowledge data.

9. A non-transitory computer-readable recording medium that includes a program recorded thereon, the program including instructions that cause the computer to carry out:
receiving observed event data indicating an observed event; and
determining whether or not the received observed event data is not needed based on pieces of observed event data other than the received observed event data and knowledge data.

10. The non-transitory computer-readable recording medium according to claim 9,
wherein, in the determining, an analysis is performed on the received observed event data based on the knowledge data, and it is determined that the received observed event data is not needed if it is determined that the received observed event data can be derived from the analysis result and the other pieces of observed event data.

11. The non-transitory computer-readable recording medium according to claim 9,
wherein, in the determining, backward inference is performed on the received observed event data, and it is determined that the received observed event data is not needed on a condition that, with respect to the obtained inference result, when the inference is traced back from the received observed event data, any of the other pieces of observed event data are necessarily reached.

12. The non-transitory computer-readable recording medium according to claim 9,
wherein, in the determining, it is determined, on a condition that the received observed event data and an event expected to be observed hold true at the same time, that the received observed event data is not needed if the event expected to be observed has not been observed, or if the event expected to be observed cannot be derived by backward inference from another observation based on the knowledge data.
